(19) United States
(12) Patent Application Publication
(10) Pub. No.: US 2001/0015561 A1
(43) Pub. Date: Aug. 23, 2001

(54) Convenient force saving pincer

(76) Inventor: Shao-Chien Tseng, Taoyuan (TW)

Correspondence Address: Keith Kline, PRO-TECHTOR INTERNATIONAL SERVICES, 20775 Norada Court, Saratoga, CA, 95070-3018, US

(21) Appl. No.: 09/774,748

(22) Filed: Jan. 30, 2001

(30) Foreign Application Priority Data
Feb. 21, 2000 (CN) 00205479.5

(51) Int. Cl. B25B 7/10

(52) U.S. Cl. 294/16; 294/118

(57) ABSTRACT

A convenient force saving pincer comprising at least a handle unit, a spring leaf, a clamping unit and two pivotal connecting units, wherein, the handle unit is formed from a spring leaf in a wave form with two ends thereof connected with the front ends of two grasping stems; the clamping unit is formed by pivotal connecting pivot ends of the two clamping stems provided pivotally each with a clamping sheet; the two pivotal connecting units are composed each of a receiving sleeve which pivotally connect with a slide sleeve. The receiving and the slide sleeves can be freely adjusted for positioning on the clamping stems and the grasping stems respectively. By connecting the two pivotal connecting units with the handle unit and the clamping unit, the two pivotal connecting units form respectively lever fulcrums of the two clamping stems and the grasping stems, this control the extent of opening of the clamping unit for clamping; so that when a user compresses the handle unit to make clamping action of the clamping sheets via the two pivotal connecting units and the pivot portions of the two clamping stems, the pincer body can have the function of clamping tight to pick up an article without changing for another clamping tool.

### BACKGROUND OF THE INVENTION

1. Field of the invention

The present invention is related to a convenient force saving pincer, and especially to a pincer which is suitable for clamping to pick up a heavy article, positions of two pivotal connecting units and a handle of the pincer can be adjusted to appropriately control the extent of opening of the pincer body, and a user can conveniently clamp to pick up an article without too much effort. The present invention is force saving and convenient and thus is practically valuable.

2. Description of the Prior Art

Clamping tools (normally called pincers) are very widely used hand tools, they are generally used to clamp and move articles with dirt, high temperatures or chemical attack and thus not able to be hold with hands. Taking the clamping tool structures available in the markets as examples, they are generally composed of a stem and another similar stem pivotally connected at and with a suitable area on the former stem. The two stems form on their ends a clamping portion, and on the other ends thereof a grasping portion. A user can grasp the grasping portion to open and close the clamping portion by leverage about the lever pivot of the two stems; and the clamping portion can thus clamp and move articles.

However, a conventional clamping tool is composed of two individual stems, extent of opening of its clamping portion thereby can only reach a certain degree and thus size of article that can be clamped is limited, hence the clamping tool can only be used for limited situations. A user must use clamping tools of various sizes for clamping different articles, this results a trouble of storage of a plurality of clamping tools, and appears that the conventional clamping tools have the defects of difficulty for clamping different articles. And this is the motive of the present invention to study a solution for the problem, and the inventor of the present invention develops the present invention based on his experience of years of designing and development.

### SUMMARY OF THE INVENTION

The main object of the present invention is to study a clamping tool which is adjustable in the extent of opening thereof, so that a user can use it for clamping various articles.

To get the above object, in practice, a pincer body is formed from at least a handle unit, a spring leaf, a clamping unit and two pivotal connecting units.

Wherein, the handle unit is formed from a spring leaf in a wave form with the two ends thereof connected with two grasping stems. The front ends of the two grasping stems can be fixedly connected respectively with the ends of the spring leaf, the rear ends of the two grasping stems both have a grasping portion to be held by a user. Elastic flexibility of the spring leaf renders the pincer body to be stretched outwardly at any time, so that the pincer body can be used to clamp at any time.

The clamping unit is formed by pivotal connecting of the two clamping stems, the ends of the clamping stems are pivot ends combinable with each other, the opposite ends of the two are provided pivotally each with an arciform clamping sheet which can freely sway. The two clamping stems can make opening and closing for clamping by means of the pivot ends, and the arciform clamping sheets have claws to tightly clamp an article.

The two pivotal connecting units are composed each of a receiving sleeve which connect with a slide sleeve via a pivot axle, the receiving sleeve and the slide sleeve both have a function of freely adjusting for positioning on the clamping stems and the grasping stems respectively. By connecting of the two pivotal connecting units with the handle unit and the clamping unit, a convenient force saving pincer body is formed. The pincer body can control the extent of opening of the clamping unit by adjustment of the positions of the two pivotal connecting units on the handle unit and the clamping unit without consumption of overly large force or changing for another clamping tool, and can directly be used to firmly clamp various articles; it has the effect of force saving.

The present invention will be apparent after reading the detailed description of the preferred embodiment thereof in reference to the accompanying drawings.

### BRIEF DESCRIPTION OF THE DRAWINGS

FIG. 1 is a perspective view of the present invention

FIG. 2 is a front view of the present invention;

FIG. 3 is a sectional view of the two pivotal connecting units of the present invention;

FIG. 4 is a schematic view showing the present invention in use;

FIG. 5 is another schematic view showing the present invention in use;

FIG. 6 is a schematic view showing a state of clamping in use of the present invention when being adjusted to form the state as shown in FIG. 5;

FIG. 7 is a perspective view of another embodiment of the present invention;

FIG. 8 is a perspective view of a further embodiment of the present invention.

### DETAILED DESCRIPTION OF THE PREFERRED EMBODIMENT

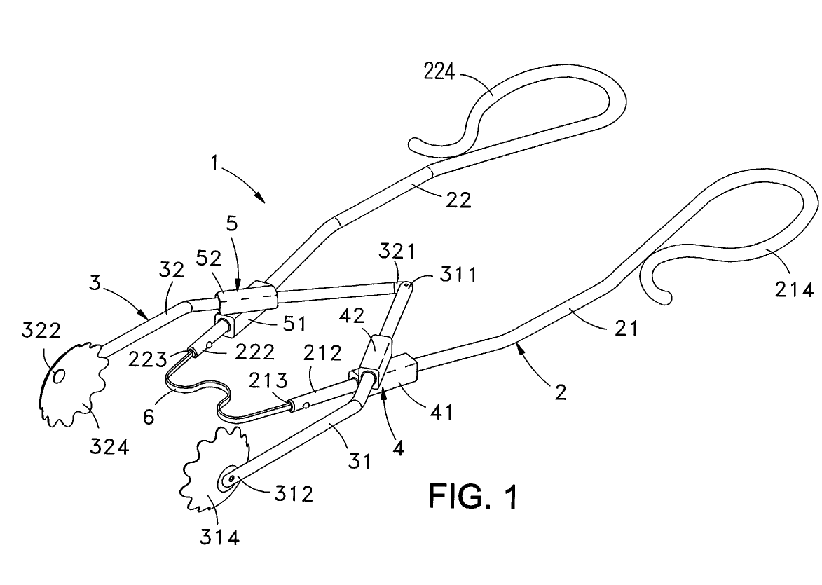

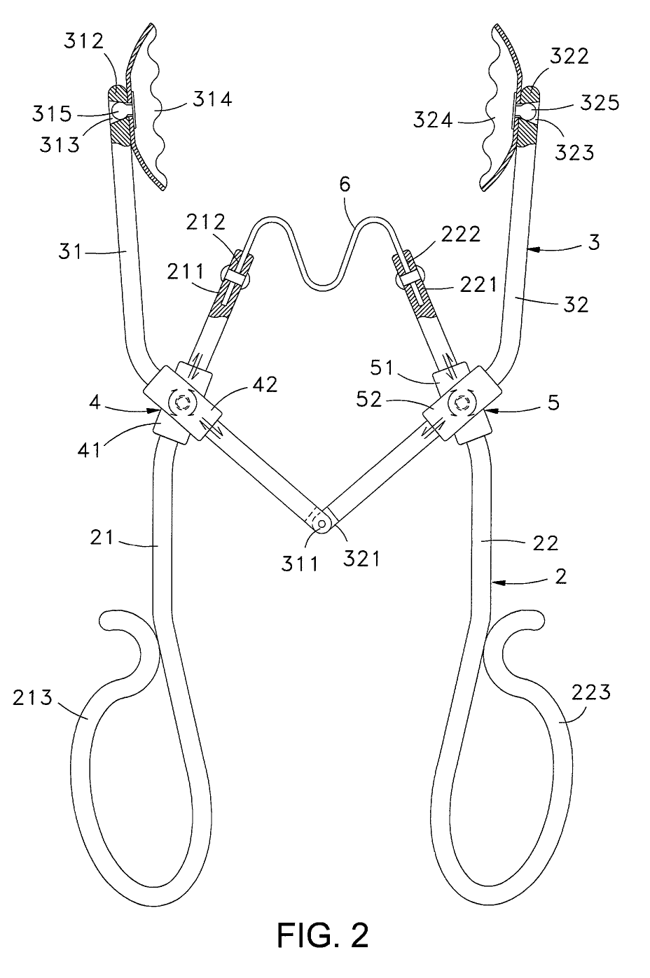

Referring to the FIG. 1 firstly, the convenient force saving pincer of the present invention has a pincer body 1 comprised at least of a handle unit 2, a spring leaf 6, a clamping unit 3 and two pivotal connecting units 4, 5.

Wherein, the handle unit 2 is formed from a spring leaf 6 with the two ends thereof connected with two grasping stems 21 and 22 (referring to FIG. 2). The spring leaf 6 is in a wave form and is made by bending of a flexible steel sheet. The front ends 211 and 221 of the two grasping stems 21 and 22 are provided respectively with slits 212 and 222 and can be fixedly connected respectively with the ends of the spring leaf 6. The rear ends of the two grasping stems 21, 22 have grasping portions 213, 223 respectively to be held by a user. Elastic extensibility and contractibility of the spring leaf 6 renders the grasping stems 21, 22 of the handle unit 2 to be stretched outwardly at any time.

The clamping unit 3 is formed by pivotal connecting of two clamping stems 31, 32 (referring to FIG. 2), the ends of the clamping stems 31, 32 are provided with pivot portions 311, 321 combinable with each other, the opposite ends 312, 322 of the two clamping stems 31, 32 are provided respectively with a conical hole 313 and 323 which can be mounted respectively with pivots axles 315, 325 of arciform clamping sheets 314, 324 able to freely sway and provided with claws. The pivot portions 311, 321 of the two clamping stems 31, 32 can be combined to form a lever fulcrum to make opening and closing of the two clamping stems 31, 32 for clamping an article.

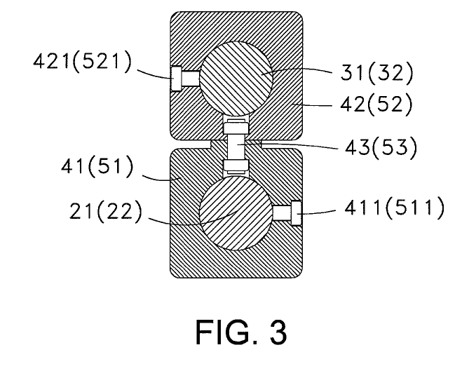

The pivotal connecting units 4, 5 are provided respectively with receiving sleeves 42, 52 which connect respectively with slide sleeves 41, 51 via pivot axles 43, 53 (referring to FIG. 3). The receiving sleeves 42, 52 and the slide sleeves 41, 51 can be slipped respectively over the clamping stems 31, 32 and the grasping stems 21, 22 (referring to FIG. 1). The receiving sleeves 42, 52 and the slide sleeves 41, 51 each has a function of freely adjusting for positioning on the clamping stems 31, 32 and the grasping stems 21, 22 respectively for free moving. The receiving sleeves 42, 52 and the slide sleeves 41, 51 are further provided respectively with screws 421, 521 and 411, 522 (referring to FIG. 3). By screwing locking of the screws 421, 521 and 411, 522, the receiving sleeves 42, 52 and the slide sleeves 41, 51 can be fixedly mounted on the clamping stems 31, 32 and the grasping stems 21, 22. Thereby, the receiving sleeves 42, 52 and the slide sleeves 41, 51 can have the function of free adjusting for positioning.

By connecting of the two pivotal connecting units 4, 5 with the handle unit 2 and the clamping unit 3, the convenient force saving pincer body 1 is formed (referring to FIG. 1). In this way, the two pivotal connecting units 4, 5 form respectively lever fulcrums of the two clamping stems 31, 32 and the grasping stems 21, 22, so that when a user compresses the handle unit 2 to in turn make clamping action of the arciform clamping sheets 314, 324 via the two pivotal connecting units 4, 5 and the pivot portions 311, 321 of the two clamping stems 31, 32. Thereby, the pincer body 1 can have the function of clamping an article.

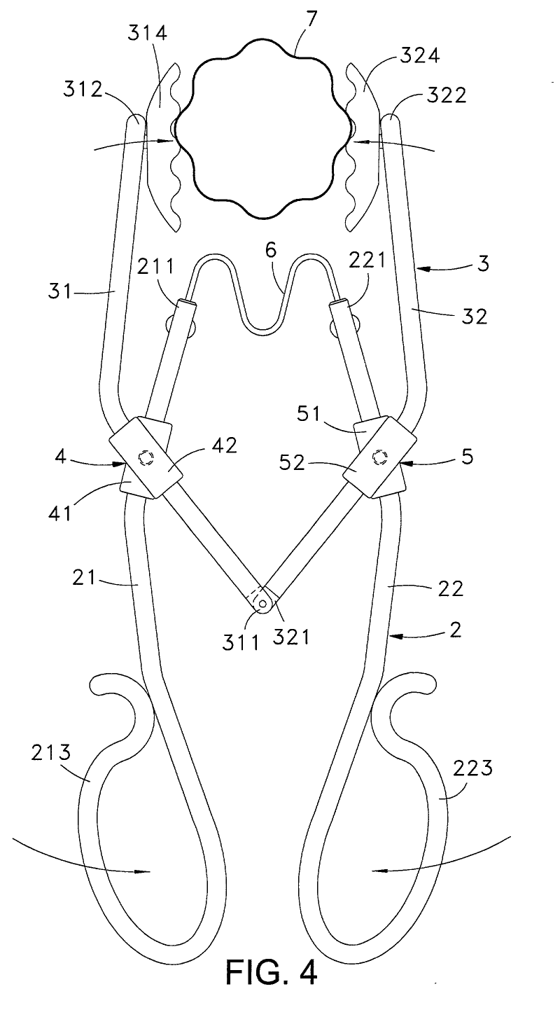

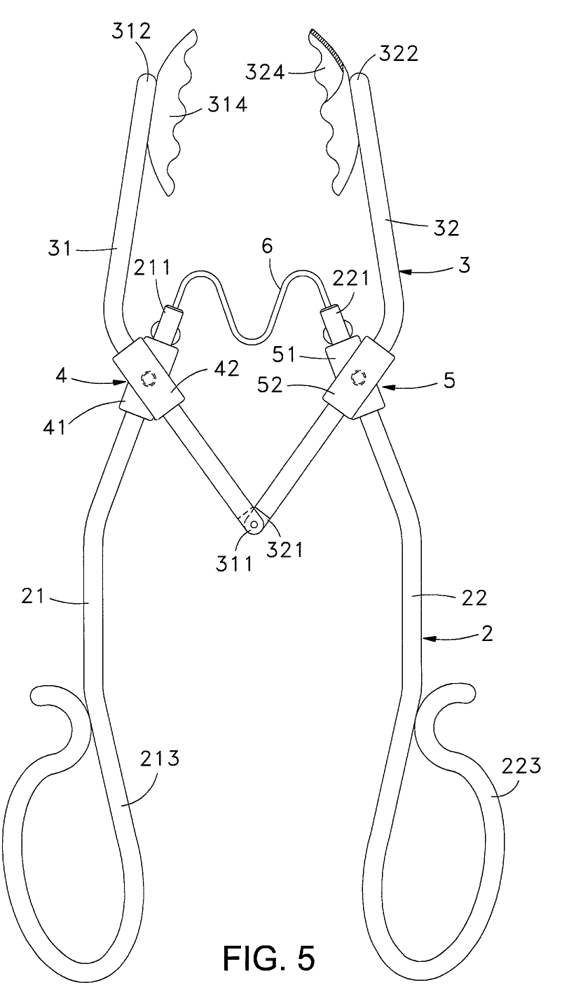

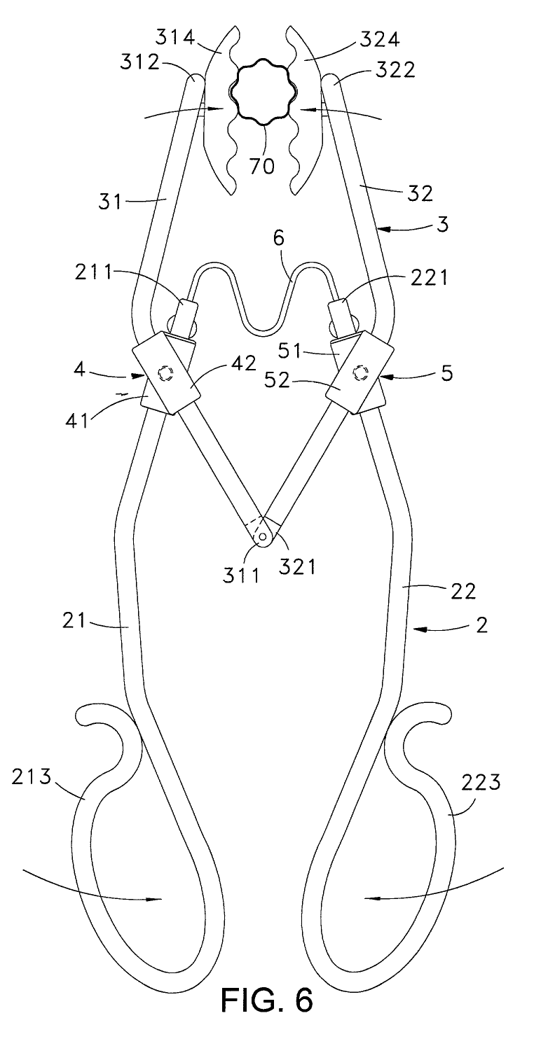

When a user wants to pick up by clamping an article 7 with a larger volume, he can adjust the positions of the pivotal connecting units 4, 5 on the grasping stems 21, 22 to render the pivotal connecting units 4, 5 to get closer to the grasping portions 213, 223 respectively of the two grasping stems 21, 22 (referring to FIG. 2). By then, the two clamping stems 31, 32 of the clamping unit 3 will be controlled by the pivotal connecting units 4, 5 to move gradually away from each other about the fulcrum or the pivot portions 311, 321, this can increase the extent of opening of the arciform clamping sheets 314, 324. If the user wants to pick up by clamping the article 7 by compressing the handle unit 2, the handle unit 2 makes clamping action of the arciform clamping sheets 314, 324 with claws via the two pivotal connecting units 4, 5 and the pivot portions 311, 321 of the two clamping stems 31, 32 (referring to FIG. 4). Thereby, the pincer body 1 can pick up the article 7 with a suitable extent of opening of the arciform clamping sheets 314, 324. And the user can feel convenient that he can surely pick up various articles without changing the pincer for other clamping tools. On the contrary, if the user wants to pick up by clamping an article 70 with a smaller volume, he can adjust the positions of the pivotal connecting units 4, 5 on the grasping stems 21, 22 to render the pivotal connecting units 4, 5 to get closer to the front ends 211, 221 of the two grasping stems 21, 22 (referring to FIG. 5). By then, the two clamping stems 31, 32 of the clamping unit 3 will be controlled by the pivotal connecting units 4, 5 to move gradually toward to each other about the fulcrum or the pivot portions 311, 321, this can decrease the extent of opening of the arciform clamping sheets 314, 324. If the user is to pick up by clamping the article 7 by compressing the handle unit 2, the handle unit 2 makes clamping action of the arciform clamping sheets 314, 324 with claws via the two pivotal connecting units 4, 5 and the pivot portions 311, 321 of the two clamping stems 31, 32 (referring to FIG. 6). Thereby, the pincer body 1 can pick up the article 70 with a suitable extent of opening of the arciform clamping sheets 314, 324. Thereby, the pincer body 1 has the function of adjusting to reduce the extent of opening. By free swaying of the arciform clamping sheets 314, 324 of the pincer body 1, the clamping sheets 314, 324 can move in pursuance of the shape of the surface of the article 70, and by tight engaging the article 70 by the arciform claws of the clamping sheets 314, 324, the user can pick up the article 70 firmly without consumption of overly large force to get the effect of force saving.

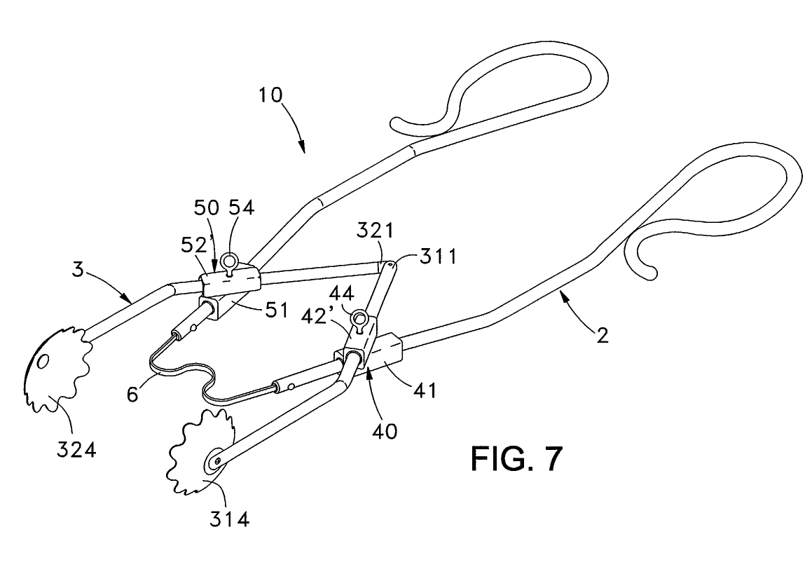

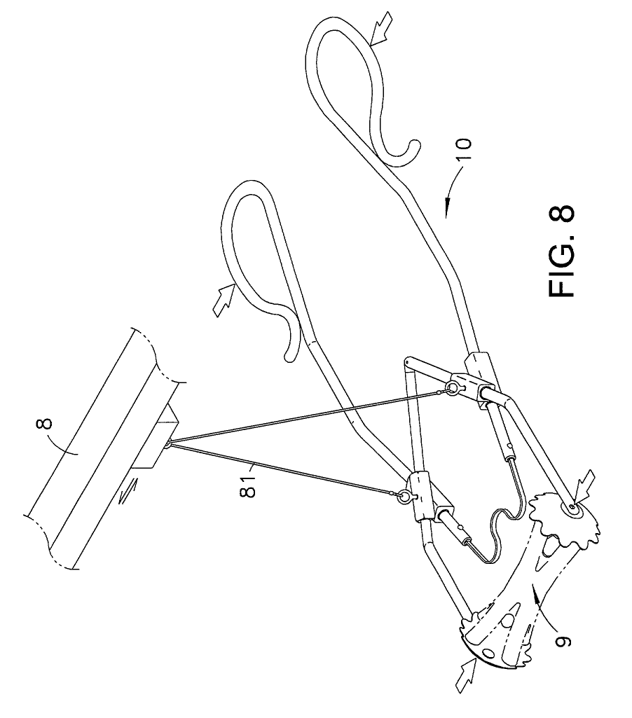

When in use of the pincer body 1, in pursuance of the environment of using, a pair of hanging rings can be provided on the receiving sleeves 42, 52 of the pivotal connecting units 4, 5, the pincer body 1 can thus be hung at a desired position to be convenient for operation of the user. For example, a pincer body 10 can be provided on receiving sleeves 42′, 52′ of pivotal connecting units 40, 50 with hanging rings 44 and 54 respectively (referring to FIG. 7). The hanging rings 44 and 54 on the pincer body 10 can be provided with a flexible hanging rope 81 fixedly mounted on a hanging rack 8 above the pincer body 10. When the pincer body 10 is used to clamp a heavier workpiece 9, the flexible hanging rope 81 can flexibly bear the weight of the workpiece 9, this can alleviate the effort of a user in operation (referring to FIG. 8). This mode of practice is extremely suitable for a production line in manufacturing products of which the contours are irregular or variant, and can effectively reduce the rate of getting fatigue of the operator. Thereby, the pincer body 10 has an additional industrial value in increasing the capability of production. And this is another embodiment of the present invention.

In conclusion, in the convenient force saving pincer of the present invention, by connecting of the two pivotal connecting units 4, 5 with the handle unit 2 and the clamping unit 3, the two pivotal connecting units 4, 5 form respectively lever fulcrums of the two clamping stems 31, 32 and the grasping stems 21, 22; so that when a user compresses the handle unit 2, it makes clamping action of the arciform clamping sheets 314, 324 via the two pivotal connecting units and the pivot portions 311, 321 of the two clamping stems 31, 32. Thereby, the pincer body can have the function of clamping an article. And the extent of opening of the arciform clamping sheets 314, 324 of the pincer body can be suitably adjusted, so that a user can pick up an article firmly without consumption of overly large force or changing for another clamping tool to get the effect of force saving in picking up by clamping the article.

Having thus described my invention which is novel, advanced and practical, what I claim as new and desire to be secured by Letters Patent of the United States are:

1. A convenient force saving pincer comprising at least:
a handle unit, having two grasping stems, the front ends of said two grasping stems fixedly connected respectively with two ends of a spring leaf, said grasping stems both form a grasping portion to be held by a user;
a clamping unit formed from two clamping stems, said clamping stems each has one end combined with each other to form pivot ends, the opposite ends of said clamping stems are provided pivotally each with a clamping sheet; and
two pivotal connecting units composed each of a receiving sleeve which connect with a slide sleeve, said receiving sleeve and said slide sleeve both have a function of freely adjusting for positioning on said clamping stems and said grasping stems respectively;
by connecting of said pivotal connecting units with said handle unit and said clamping unit, said convenient force saving pincer body is formed.

2. A convenient force saving pincer as claimed in claim 1, wherein, said spring leaf is in a wave form.

3. A convenient force saving pincer as claimed in claim 1, wherein, said receiving sleeves are provided with hanging rings.
